(19) United States
(12) Patent Application Publication
(10) Pub. No.: US 2018/0081499 A1
(43) Pub. Date: Mar. 22, 2018

(54) METHOD AND SYSTEM FOR PROCESSING CROWD-SENSED DATA TO GENERATE ACTIONABLE INSIGHTS OF GEOGRAPHICAL AREAS

(71) Applicant: XEROX CORPORATION, Norwalk, CT (US)

(72) Inventors: Amandeep Chugh, Chandigarh (IN); Mridula Singh, Uttar Pradesh (IN); Tridib Mukherjee, Bangalore (IN); Preethy Varma, Cochin (IN); Deepthi Chander, Cochin (IN); Gayatri Sivakumar, Cochin (IN); Chitra Senthamilselvan, Tittagudi (IN)

(21) Appl. No.: 15/268,698

(22) Filed: Sep. 19, 2016

(51) Int. Cl. G06F 3/0482; G06F 3/0481; G06F 3/0483

(52) U.S. Cl. CPC G06F 3/0482; G06F 3/0483; G06F 3/0481

(57) ABSTRACT

The disclosed embodiments illustrate methods and systems for processing crowd-sensed data to generate actionable insights of geographical areas. The method includes extracting the crowd-sensed data, corresponding to one or more events in a geographical area, from one or more data sources. The extracted crowd-sensed data is stored in a storage device based on at least a time, a location, and an event category associated with the extracted crowd-sensed data. The method further includes aggregating the stored crowd-sensed data based on at least the location and the event category. The method further includes rendering graphical distributions of the one or more events in the geographical area, based on at least the aggregated data, on a user interface displayed on a display screen of a computing device. The graphical distributions of the one or more events are representative of the actionable insights of the geographical area.

### TECHNICAL FIELD

The presently disclosed embodiments are related, in general, to a data processing system. More particularly, the presently disclosed embodiments are related to a method and a system for processing crowd-sensed data to generate actionable insights of geographical areas.

### BACKGROUND

With the proliferation of social media platforms, on-line blogs, and mobile applications, city related events are now-a-days actively discussed by individuals (e.g., residents), via social media feeds and open public forums over the web. Further, the residents may provide implicit and explicit feedback on city-related issues via various means, such as, mobile crowdsourcing, crowd-sensing, and human participatory sensing systems. Furthermore, sensors deployed in the various regions of the city may provide sensor-based data associated with various city-related issues, such as, pollution-related and crime-related issues, in such regions.

All such information corresponding to the publically available social media feeds and other sources may be surveyed and analyzed by city agencies for generating meaningful knowledge that may be in turn utilized for effective city planning. For example, a city agency may find out various regions in a city that are having pollution-related issues because of garbage and how is it impacting the residents. In another example, a city transportation agency may get insights on whether public transport services are commensurate with demands in the various regions of the city or not. In yet another example, a traffic department may know the insights on crime affected areas, as well as spatial-temporal distribution and potential causes of regular traffic problems.

However, in certain scenarios, such generation of meaningful knowledge from the publically available social media feeds and other sources may be a non-trivial task, due to various reasons. Firstly, such sources may be non-standardized and heterogeneous in nature with open information format. Secondly, the processing and aggregation of data collected from publically available social media feeds and other sources to identify distinct set of issues may be an arduous task. Thirdly, the insights may not be meaningful enough when presented in raw format instead of user-friendly data format. Thus, there is required a method and system for generating meaningful and actionable insights of the city-related issues based on automated analysis of the feedback provided by users.

Further, limitations and disadvantages of the conventional and traditional approaches will become apparent to one skilled in the art, through a comparison of described systems with some aspects of the present disclosure, as set forth in the remainder of the present application and with reference to the drawings.

### SUMMARY

According to embodiments illustrated herein, there is provided a method for processing crowd-sensed data to generate actionable insights of geographical areas. The method includes extracting, by one or more data extracting processors at a computing server, the crowd-sensed data, corresponding to one or more events in a geographical area, from one or more data sources over a communication network. The extracted crowd-sensed data is further stored in a storage device based on at least a time, a location, and an event category associated with the extracted crowd-sensed data. The method further includes aggregating, by one or more data aggregating processors at the computing server, the stored crowd-sensed data based on at least the location and the event category to generate one or more sets of aggregated data. Each of the one or more sets of aggregated data is associated with an event of the one or more events in the geographical area. The method further includes rendering, by one or more processors at the computing server, one or more graphical distributions of the one or more events in the geographical area, based on at least the generated one or more sets of aggregated data, on a user interface displayed on a display screen of a computing device. The one or more graphical distributions of the one or more events are representative of one or more actionable insights of the geographical area.

According to embodiments illustrated herein, there is provided a system for processing crowd-sensed data to generate actionable insights of geographical areas. The system includes one or more data extracting processors that are configured to extract the crowd-sensed data, corresponding to one or more events in a geographical area, from one or more data sources. The extracted crowd-sensed data is further stored in a storage device based on at least a time, a location, and an event category associated with the extracted crowd-sensed data. The system further includes one or more data aggregating processors that are configured to aggregate the stored crowd-sensed data based on at least the location and the event category to generate one or more sets of aggregated data. Each of the one or more sets of aggregated data is associated with an event of the one or more events in the geographical area. The system further includes one or more processors that are configured to render one or more graphical distribution of the one or more events in the geographical area, based on the generated one or more sets of aggregated data, on a user interface displayed on a display screen of a computing device. The one or more graphical distributions of the one or more events are representative of the actionable insights of the geographical area

According to embodiment illustrated herein, there is provided a computer program product for use with a computer. The computer program product includes a non-transitory computer readable medium. The non-transitory computer readable medium stores a computer program code for processing crowd-sensed data to generate actionable insights of geographical areas. The computer program code is executable by one or more processors to extract the crowd-sensed data, corresponding to one or more events in a geographical area, from one or more data sources over a communication network. The extracted crowd-sensed data is further stored in a storage device based on at least a time, a location, and an event category associated with the extracted crowd-sensed data. The computer program code is further executable by the one or more processors to aggregate the stored crowd-sensed data based on at least the location and the event category to generate one or more sets of aggregated data. Each of the one or more sets of aggregated data is associated with an event of the one or more events in the geographical area. The computer program code is further executable by the one or more processors to render one or more graphical distribution of the one or more events in the geographical area, based on the generated one or more sets of aggregated data, on a user interface displayed on a display screen of a computing device. The one or more graphical distributions of the one or more events are representative of one or more actionable insights of the geographical area.

### BRIEF DESCRIPTION OF DRAWINGS

The accompanying drawings illustrate the various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate the scope and not to limit it in any manner, wherein like designations denote similar elements, and in which:

FIG. 1 is a block diagram of a system environment in which various embodiments can be implemented, in accordance with at least one embodiment;

FIG. 2 is a block diagram that illustrates a system for processing crowd-sensed data to generate one or more actionable insights of a geographical area, in accordance with at least one embodiment;

FIG. 3 is a flowchart that illustrates a method for processing crowd-sensed data to generate one or more actionable insights of a geographical area, in accordance with at least one embodiment; and

FIG. 4 is a block diagram that illustrates a visualization of a dashboard displaying one or more actionable insights corresponding to one or more events in a geographical area, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on, indicate that the embodiment(s) or example(s) may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

Definitions: The following terms shall have, for the purposes of this application, the meanings set forth below.

A “computing device” refers to a computer, a device (that includes one or more processors/microcontrollers and/or any other electronic components), or a system (that performs one or more operations according to one or more sets of programming instructions, code, or algorithms) associated with an individual. In one example, an individual (e.g., a citizen) may utilize the computing device to discuss or report about one or more city related events (e.g., a natural disaster related event, a traffic related event, a pollution related event, and/or the like) on various platforms, such as, one or more social media platforms (e.g., Facebook®, Twitter®, or Instagram®). In another exemplary scenario, another individual (associated with a city agency that provides services to citizens in a geographical area) may utilize the computing device to view an occurrence and current status of the one or more city related events that may be of interest to such individual. Examples of the computing device may include, but are not limited to, a desktop computer, a laptop, a personal digital assistant (PDA), a mobile device, a smartphone, and a tablet computer (e.g., iPad® and Samsung Galaxy Tab®).

A “geographical area” refers to an area of land, such as, a region, a county, a city, a town, a village, a district, a locality, a state, or a country. In an embodiment, the geographical area may be associated with one or more events.

“Crowd-sensed data” refers to data collected from one or more individuals over a communication platform. In an embodiment, the crowd-sensed data may correspond to one or more events of a geographical area. For example, the one or more individuals from the geographical area may have observed an aberration in at least one of a public service, a public infrastructure, a private service, or a private infrastructure. Based on at least the observations, the one or more individuals may have reported or discussed the aberration on various platforms, such as, social media platforms or mobile applications, through multimedia content (e.g., text messages, audio clips, or video clips). The one or more users may also report or discuss about natural disasters or environmental problems. The term “crowd-sensed data” is interchangeably referred as “event report” hereinafter.

An “event” refers to an aberration in at least one of a public service, a public infrastructure, a private service, or a private infrastructure. In an embodiment, the event may also correspond to a natural disaster or an environmental problem. In an embodiment, the event may be reported by at least one individual by use of one or more event reporting platforms, such as, social media platforms, mobile applications, and/or the like.

A “data source” refers to a source from which data, related to one or more events reported by one or more individuals, may be extracted. Examples of the data source may correspond to one or more of, but is not limited to, a social media source, an open online forum, a mobile application, and an online web source.

A “time” refers to a measured or measurable period during which one or more events may have occurred. In an embodiment, an individual may include the time of observation (or occurrence) of the one or more events while reporting or discussing about the one or more events on various platforms, such as, social media platforms.

A “location” may refer to a point in space where one or more events may have occurred. In an embodiment, an individual may include the location (e.g., an exact location, a landmark location, and an area or society location) of the one or more events while reporting or discussing about the one or more events on various platforms, such as, social media platforms.

An “event category” refers to a type of event or objection. For example, the category of an event may correspond to at least one of, but is not limited to, traffic, potholes, non-operational street lamps, fire, noise, pollution, illegal parking, and plumbing. Further, in an embodiment, a category may be dynamically added to the list of the one or more categories, in case an event does not fall under any category from the one or more categories. Further, in an embodiment, the category may correspond to one or more domains, such as, a business domain, a health domain, a traffic domain, a society domain, a regional domain, and/or the like.

A “reference location” refers to a landmark location to which an event may be associated with. In an embodiment, the association of the event with the reference location may be determined based on at least a threshold distance associated with the reference location and a distance of the location associated with the event from the reference location. For example, the threshold distance of the reference location is “1 km” and the distance of the location associated with the event from the reference location is “0.5 km.” Further, the distance of the location associated with the event from the reference location, i.e., “0.5 km” is within the threshold distance of the reference location. In such a scenario, the event may be associated with the reference location.

A “threshold distance” refers to a distance value defined by an individual for a reference location. In an embodiment, the threshold distance may be utilized to determine an association of an event with the reference location.

A “user interface (UI)” refers to an interface or a platform that may facilitate an individual to interact with an associated computing device, such as, a computer, a laptop, or smartphone. The individual may utilize various input mediums to interact with the UI, such as, but are not limited to, a keypad, mouse, joystick, any touch-sensitive medium (e.g., a touch-screen or touch sensitive pad), voice recognition, gestures, video recognition, and so forth. Hereinafter, the term “UI” is interchangeably referred to as “GUI.”

An “actionable insight” refers to a piece of information, available in form of text, audio, video, image, or graphical content, which may enable an individual, for example, an administrator associated with a city agency, to make a decision pertaining to one or more resolutions of one or more events. The one or more events may be associated with one or more locations in a geographical area.

A “set of aggregated data” refers to a set of numerical or non-numerical information that may be collected from multiple sources and/or on multiple measures, variables, or individuals, and may further be compiled into data summaries or summary reports, typically for the purposes of public reporting or statistical analysis, such as, examining trends, making comparisons, or revealing information and insights that may not be observable when data elements are viewed in isolation.

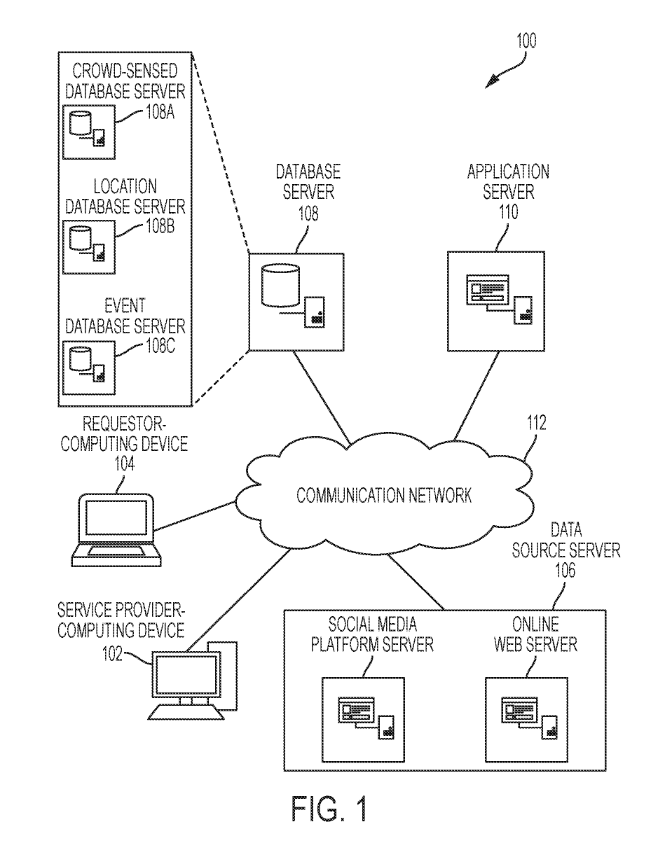

FIG. 1 is a block diagram of a system environment in which various embodiments of a method and a system for processing crowd-sensed data to generate actionable insights of geographical areas may be implemented. With reference to FIG. 1, there is shown a system environment 100 that includes a service provider-computing device 102, a requestor-computing device 104, a data source server 106, a database server 108, and an application server 110. The service provider-computing device 102, the requestor-computing device 104, the data source server 106, the database server 108, and the application server 110 are communicatively coupled with each other over one or more communication networks, such as, a communication network 112. For simplicity, FIG. 1 shows one service provider-computing device, such as, the service provider-computing device 102, one requestor-computing device, such as, the requestor-computing device 104, one data source server, such as, the data source server 106, one database server, such as the database server 108, and one application server, such as, the application server 110. However, it will be apparent to a person having ordinary skill in the art that the disclosed embodiments may also be implemented using multiple service provider-computing devices, multiple requestor-computing devices, multiple data source servers, multiple database servers, and multiple application servers, without deviating from the scope of the disclosure.

The service provider-computing device 102 may refer to a computing device (associated with a service provider) that may be communicatively coupled to the communication network 112. The service provider may correspond to an individual, who may utilize the service provider-computing device 102 to define various parameters that may be required for processing crowd-sensed data to generate one or more actionable insights of a geographical area. For example, the service provider may utilize the service provider-computing device 102 to define one or more of, but not limited to, one or more event categories in the geographical area, one or more reference locations in the geographical area, and a threshold distance associated with each of the one or more reference locations.

The service provider-computing device 102 may include one or more processors in communication with one or more memory units. Further, in an embodiment, the one or more processors may be operable to execute one or more sets of computer-readable code, instructions, programs, or algorithms, stored in the one or more memory units, to perform one or more operations. In an embodiment, the service provider may utilize the service provider-computing device 102 to communicate with the requestor-computing device 104, the data source server 106, the database server 108, or the application server 110, via the communication network 112.

The service provider-computing device 102 may further include a display screen that may be configured to display one or more GUIs rendered by a computing server, such as, the application server 110. For example, the application server 110 may render a GUI displaying a request for the one or more actionable insights of the geographical area, received from the requestor-computing device 104 over the communication network 112.

Examples of the service provider-computing device 102 may include, but are not limited to, a personal computer, a laptop, a PDA, a mobile device, a tablet, or any other computing devices.

The requestor-computing device 104 may refer to a computing device (associated with a requestor) that may be communicatively coupled to the communication network 112. The requestor may correspond to an individual, such as, an administrator associated with a city agency, who may utilize the requestor-computing device 104 to transmit the request to the service provider-computing device 102, the database server 108, or the application server 110 over the communication network 112. The request may include at least a query and one or more preferences for one or more events for which the requestor wishes to view the one or more actionable insights in one or more locations of the geographical area.

The requestor-computing device 104 may include one or more processors in communication with one or more memory units. Further, in an embodiment, the one or more processors may be operable to execute one or more sets of computer-readable code, instructions, programs, or algorithms, stored in the one or more memory units, to perform one or more operations. In an embodiment, the requestor may utilize the requestor-computing device 104 to communicate with the service provider-computing device 102, the application server 110, or the database server 108 over the communication network 112.

The requestor-computing device 104 may further include a display screen that may be configured to display one or more GUIs rendered by the computing server, such as, the application server 110. For example, the application server 110 may render one or more graphical distributions of the one or more events in the geographical area. The one or more graphical distributions are representative of at least a spatial distribution, a temporal distribution, and a frequency distribution of the one or more events. Further, the one or more graphical distributions may include information depicting current status (e.g., solved or unsolved) of the one or more events.

Examples of the requestor-computing device 104 may include, but are not limited to, a personal computer, a laptop, a PDA, a mobile device, a tablet, or any other computing devices.

The data source server 106 may refer to a computing device, a software framework hosting an application or a software service, a communication channel, and/or a platform that may be utilized by one or more individuals (e.g., one or more citizens) to discuss or report about the one or more events that may have occurred in and around their current location of the geographical area. The one or more events may correspond to one or more aberrations in at least one of a public service, a public infrastructure, a private service, or a private infrastructure.

In an embodiment, the data source server 106 may correspond to one or more of, but is not limited to, a social media platform server, an open data website, a conversation database (storing telephonic or mobile conversations), a complaint database server, an open online forum server, a mobile application, and an online web source server. In case of occurrences of the one or more events, the one or more individuals may utilize their corresponding computing devices, such as, a smartphone, a laptop, or a smart watch, to discuss or report about the one or more events on the one or more data source servers, such as, the data source server 106. The one or more individuals may discuss or report about the one or more events, occurred in the one or more locations of the geographical area, on the data source server 106 through multimedia content. For example, the multimedia content may comprise content describing about the one or more events and other associated information (e.g., time or location of occurrence of the one or more events). The multimedia content may be in the form of one or more text messages and/or one or more audio or video clips that are posted, liked, disliked, or shared by the one or more individuals on the data source server 106. The data source server 106 may store the discussed or reported data as the crowd-sensed data in a local memory or a global memory associated with the data source server 106 that may be retrieved by the database server 108 or the application server 110 to perform one or more operations. For querying the data source server 106, one or more querying languages may be utilized, such as, but not limited to, SQL, QUEL, and DMX.

The database server 108 may refer to a computing device or a storage device that may be communicatively coupled to the communication network 112. In an embodiment, the database server 108 may be configured to perform one or more database operations. Examples of the one or more database operations may include receiving/transmitting one or more queries, requests, crowd-sensed data, or content from/to one or more computing devices, such as, the service provider-computing device 102, the requestor-computing device 104, the data source server 106, or the application server 110. The one or more database operations may further include processing and storing the one or more queries, requests, crowd-sensed data, or content. For example, the database server 108 may be configured to store the crowd-sensed data, extracted from data source server 106, in a crowd-sensed database server 108A. The extracted crowd-sensed data may be stored in the crowd-sensed database server 108A in a standardized format (defined by the service provider) based on at least a time, a location, and a category associated with each of the crowd-sensed data. The database server 108 may be further configured to store the one or more reference locations of the geographical area and a corresponding threshold distance associated with each of the one or more reference locations, received from the service provider-computing device 102, in a location database server 108B. The database server 108 may be further configured to store the one or more events, defined by the service provider, in an event database server 108C. The one or more events may correspond to one or more of, but are not limited to, traffic, potholes, non-operational street lamp, fire, noise, pollution, illegal parking, and plumbing.

Further, in an embodiment, the database server 108 may store one or more sets of instructions, code, scripts, or programs that may be retrieved by the application server 110 to perform the one or more operations. For querying the database server 108, one or more querying languages may be utilized, such as, but not limited to, SQL, QUEL, and DMX. In an embodiment, the database server 108 may be realized through various technologies, such as, but not limited to, Microsoft® SQL Server, Oracle®, IBM DB2®, Microsoft Access®, PostgreSQL®, MySQL® and SQLite®, MongoDB®, and/or the like.

A person having ordinary skill in the art will understand that the scope of the disclosure is not limited to the database server 108 as a separate entity. In an embodiment, the functionalities of the database server 108 may be integrated into the data source server 106 or the application server 110 and vice-versa, without deviating from the scope of the disclosure.

The application server 110 may refer to a computing device or a software framework hosting an application or a software service that may be communicatively coupled to the communication network 112. In an embodiment, the application server 110 may be implemented to execute procedures, such as, but not limited to, the one or more sets of programs, instructions, code, routines, or scripts stored in one or more memory units for supporting the hosted application or the software service. In an embodiment, the hosted application or the software service may be configured to perform the one or more operations of the application server 110.

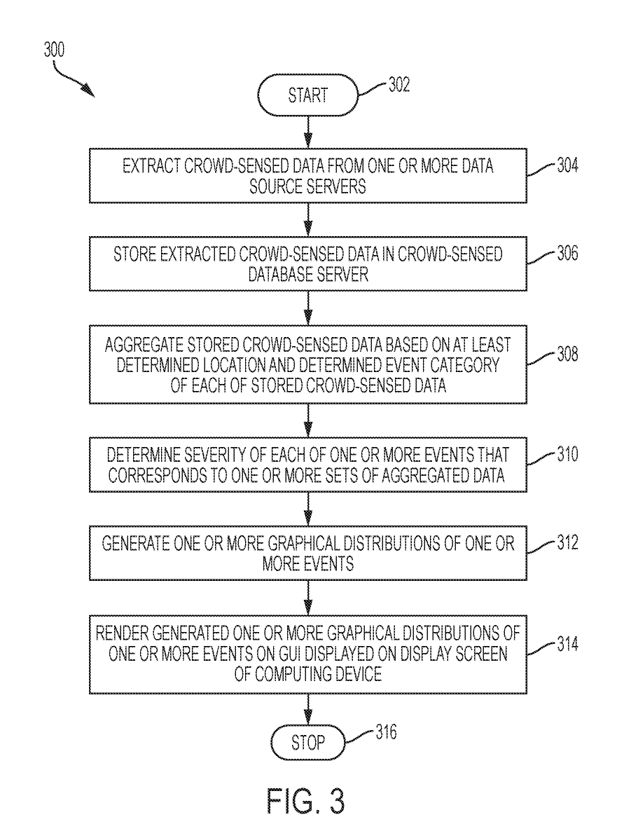

In an embodiment, the application server 110 may be configured to extract the crowd-sensed data from the data source server 106. Further, the application server 110 may be configured to determine the time, the location, and the event category of each of the extracted crowd-sensed data based on at least the content in the extracted crowd-sensed data. The determination of the time, the location, and the event category of each of the extracted crowd-sensed data has been explained in detail in conjunction with FIG. 3.

Further, in an embodiment, the application server 110 may store the extracted crowd-sourced data in a memory unit, such as, the crowd-sensed database server 108A, based on at least one or more of the time, the location, and the event category determined for each of the extracted crowd-sensed data. Further the application server 110 may be configured to aggregate the stored crowd-sensed data, based on at least one or more of the determined time, the determined location, and the determined event category, to generate one or more sets of aggregated data. In an embodiment, each of the one or more sets of aggregated data is associated with an event of the one or more events in the geographical area. The application server 110 may be further configured to determine a severity of each of the one or more events based on at least a count and recency of the crowd-sensed data, for each event category, extracted from the data source server 106. Further, in an embodiment, the application server 110 may be configured to render the one or more graphical distributions of the one or more events, based on at least the generated one or more sets of aggregated data, on a GUI displayed on a display screen of the service provider-computing device 102 or the requestor-computing device 104. The aggregation of the stored crowd-sensed data and the generation of the one or more graphical distributions have been explained in detail in conjunction with FIG. 3.

The application server 110 may be realized through various types of application servers, such as, but not limited to, a Java application server, a .NET framework application server, a Base4 application server, a PHP framework application server, or any other application server framework.

The communication network 112 may include a medium through which devices, such as, the service provider-computing device 102 and the requestor-computing device 104, and servers, such as, the data source server 106, the database server 108, and the application server 110, may communicate with each other. Examples of the communication network 112 may include, but are not limited to, the Internet, a cloud network, a Wireless Fidelity (Wi-Fi) network, a Wireless Local Area Network (WLAN), a Local Area Network (LAN), a wireless personal area network (WPAN), a Wireless Local Area Network (WLAN), a wireless wide area network (WWAN), a cloud network, a Long Term Evolution (LTE) network, a plain old telephone service (POTS), and/or a Metropolitan Area Network (MAN). Various devices in the system environment 100 may be configured to connect to the communication network 112, in accordance with various wired and wireless communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, such as, Long Term Evolution (LTE), Light Fidelity (Li-Fi), and/or other cellular communication protocols or Bluetooth (BT) communication protocols.

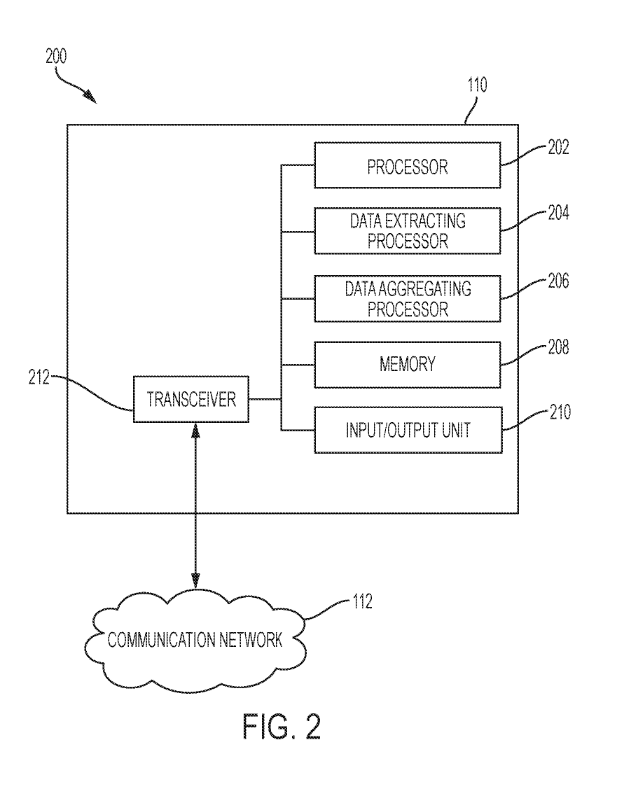

FIG. 2 is a block diagram that illustrates a system for processing crowd-sensed data to generate the one or more actionable insights of the geographical area, in accordance with at least one embodiment. With reference to FIG. 2, there is shown a system 200 that may include one or more processors, such as, a processor 202, one or more data extracting processors, such as, a data extracting processor 204, one or more data aggregating processors, such as, a data aggregating processor 206, one or more one or more memory units, such as, a memory 208, one or more input/output (I/O) units, such as, an I/O unit 210, and one or more transceivers, such as, a transceiver 212.

The system 200 may correspond to a computing device, such as, the service provider-computing device 102 or the requestor-computing device 104, or a computing server, such as, the data source server 106 or the application server 110, without departing from the scope of the disclosure. However, for the purpose of the ongoing description, the system 200 corresponds to the application server 110.

The processor 202 comprises suitable logic, circuitry, interfaces, and/or code that may be configured to execute one or more sets of instructions, programs, or algorithms stored in the memory 208 to perform the one or more operations. For example, the processor 202 may be configured to determine the time, the location, and the event category of each of the extracted crowd-sensed data. Further, the processor 202 may determine an association of each of the stored crowd-sensed data with the one or more reference locations and/or one or more time buckets. The processor 202 may be further configured to generate the one or more graphical distributions of the one or more events based on at least the generated one or more sets of the aggregated data. The processor 202 may be further configured to render the generated one or more graphical distributions on the GUI displayed on the display screen of the service provider-computing device 102 or the requestor-computing device 104 over the communication network 112. In an embodiment, the processor 202 may be communicatively coupled to the data extracting processor 204, the data aggregating processor 206, the memory 208, the I/O unit 210, and the transceiver 212. The processor 202 may be implemented based on a number of processor technologies known in the art. Examples of the processor 202 may include, but not limited to, an X86-based processor, a Reduced Instruction Set Computing (RISC) processor, an Application-Specific Integrated Circuit (ASIC) processor, and a Complex Instruction Set Computing (CISC) processor.

The data extracting processor 204 comprises suitable logic, circuitry, interfaces, and/or code that may be configured to execute the one or more sets of instructions, programs, or algorithms stored in the memory 208 to perform the one or more operations. For example, the data extracting processor 204 may be configured to extract the crowd-sensed data from the data source server 106 after a regular interval of time, for example, after every “30 minutes,” “1 hour,” “10 hours,” or “1 day,” as defined by the service provider or requested by the requestor. In an embodiment, the data extracting processor 204 may be communicatively coupled to the processor 202, the data aggregating processor 206, the memory 208, the I/O unit 210, and the transceiver 212. The data extracting processor 204 may be implemented based on a number of processor technologies known in the art. For examples, the data extracting processor 204 may be implemented using one or more of, but not limited to, an X86-based processor, a RISC processor, an ASIC processor, a CISC processor, and/or other processor. Examples of the data extracting processor 204 may include, but not limited to PTC® Arbotext, Adobe® Framemaker, LyX®, and/or BroadVision QuickSilver®.

The data aggregating processor 206 comprises suitable logic, circuitry, interfaces, and/or code that may be configured to execute the one or more sets of instructions, programs, or algorithms stored in the memory 208 to perform the one or more operations. For example, the data aggregating processor 206 may be configured to aggregate the stored crowd-sensed data, based on at least the location and the event category, to generate the one or more sets of aggregated data. Each of the one or more sets of aggregated data is associated with one of the one or more events in the geographical area. In an embodiment, the one or more sets of aggregated data may be associated with a new event that does not correspond to the one or more events. The data aggregating processor 206 may be communicatively coupled to the processor 202, the data extracting processor 204, the memory 208, the I/O unit 210, and the transceiver 212. The data aggregating processor 206 may be implemented based on a number of processor technologies known in the art. For example, the data aggregating processor 206 may be implemented using one or more of, but not limited to, an X86-based processor, a RISC processor, an ASIC processor, a CISC processor, and/or other processor.

The memory 208 may be operable to store machine code and/or computer programs having at least one code section executable by the processor 202, the data extracting processor 204, the data aggregating processor 206, the I/O unit 210, and/or the transceiver 212. The memory 208 may store the one or more sets of instructions, programs, code, or algorithms that may be executed by the processor 202, the data extracting processor 204, the data aggregating processor 206, the I/O unit 210, and/or the transceiver 212 to perform the respective one or more operations. Some of the commonly known memory implementations include, but are not limited to, a random access memory (RAM), a read-only memory (ROM), a hard disk drive (HDD), and a secure digital (SD) card. In an embodiment, the memory 208 may include the one or more machine code and/or computer programs that are executable by the processor 202, the data extracting processor 204, the data aggregating processor 206, the I/O unit 210, and/or the transceiver 212 to perform the one or more specific operations. It will be apparent to a person having ordinary skill in the art that the one or more instructions stored in the memory 208 may enable the hardware of the system 200 to perform the one or more operations.

The I/O unit 210 comprises suitable logic, circuitry, interfaces, and/or code that may be operable to facilitate the individual, such as, the service provider or the requestor, to input one or more pre-defined parameters or constraints. For example, the service provider may utilize the I/O unit 210 to provide the one or more reference locations of the geographical area and the corresponding threshold distance. In another exemplary scenario, the requestor may utilize the I/O unit 210 to input the request comprising the one or more preferences for the one or more events. The I/O unit 210 may be operable to communicate with the processor 202, the data extracting processor 204, the data aggregating processor 206, the memory 208, and/or the transceiver 212. Further, in an embodiment, the I/O unit 210, in conjunction with the processor 202 and the transceiver 212, may be operable to provide one or more responses (e.g., the one or more graphical distributions) in response to the request. For example, the one or more responses outputted by the I/O unit 210 may be either in an audio form, a video form, a graphical form, or a text form. Examples of the input devices may include, but are not limited to, a touch screen, a keyboard, a mouse, a joystick, a microphone, a camera, a motion sensor, a light sensor, and/or a docking station. Examples of the output devices may include, but are not limited to, a speaker system and a display screen.

The transceiver 212 comprises suitable logic, circuitry, interfaces, and/or code that may be configured to receive/transmit the one or more queries, crowd-sensed data, content, or other information from/to one or more computing devices (e.g., the service provider-computing device 102, the requestor-computing device 104, the data source server 106, the database server 108, or the application server 110) over the communication network 112. The transceiver 212 may implement one or more known technologies to support wired or wireless communication with the communication network 112. In an embodiment, the transceiver 212 may include circuitry, such as, but not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. The transceiver 212 may communicate via wireless communication with networks, such as, the Internet, an Intranet and/or a wireless network, such as, a cellular telephone network, a wireless local area network (LAN) and/or a metropolitan area network (MAN). The wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Light Fidelity (Li-Fi), Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

FIG. 3 is a flowchart that illustrates a method for processing the crowd-sensed data to generate one or more actionable insights of the geographical area, in accordance with at least one embodiment. With reference to FIG. 3, there is shown a flowchart 300 that is described in conjunction with FIG. 1 and FIG. 2. The method starts at step 302 and proceeds to step 304.

At step 304, the crowd-sensed data is extracted from the one or more data source servers. In an embodiment, the data extracting processor 204 may be configured to extract the crowd-sensed data from the one or more data source servers, such as, the data source server 106, over the communication network 112. The crowd-sensed data may correspond to the data (e.g., the multimedia content) about the one or more events that may have been discussed or reported (e.g., posted, shared, liked, or disliked) by the one or more individuals (e.g., the one or more citizens) on the one or more data source servers. The one or more data source servers, such as, the data source server 106, may correspond to (or may be communicatively coupled with) one or more social media platforms, one or more open data websites, one or more conversation databases (storing telephonic or mobile conversations), one or more complaint databases, one or more mobile applications, and one or more online web source servers. The one or more events may correspond to the one or more aberrations in at least one of the public service, the public infrastructure, the private service, or the private infrastructure. For example, the one or more events may correspond to one or more of, but are not limited to, crime, traffic, potholes, non-operational street lamps, fire, noise, pollution, illegal parking, electricity, garbage, water, and plumbing.

Prior to the extraction of the crowd-sensed data, the one or more individuals may utilize their corresponding computing devices to connect with the data source server 106 over the communication network 112. Thereafter, based on their observations of the one or more events in the one or more locations of the geographical area, the one or more individuals may utilize the data source server 106 to discuss or report about the one or more events. The discussed or reported data may include at least the multimedia content (e.g., an electronic message, an audio and/or a video clip) describing the one or more events. Further, in an embodiment, the discussed or reported data may correspond to the posted, shared, liked, or disliked multimedia content that is describing the one or more events. Such discussed or reported data may correspond to the crowd-sensed data.

In an embodiment, the data extracting processor 204, in conjunction with the transceiver 212, may transmit a query to the data source server 106 to extract the crowd-sensed data. In another embodiment, the data extracting processor 204 may transmit the query to the data source server 106 to extract the crowd-sensed data based on at least the request received from the requestor-computing device 104 associated with the requestor (e.g., an administrator associated with a city agency). Based on the received query, the data source server 106 may crawl the one or more social media platforms, the one or more open data websites, the one or more complaint databases, and the one or more mobile applications, using one or more application programming interfaces (APIs), hypertext markup language (HTML) parsing, and/or the like, to extract the crowd-sensed data. In an embodiment, the data source server 106 may extract the crowd-sensed data after a regular interval of time durations, for example, “30 minutes” or “1 hour,” as defined by the service provider or requested by the requestor. After extracting the crowd-sensed data, the data source server 106 may transmit extracted crowd-sensed data to the data extracting processor 204 over the communication network 112. The data extracting processor 204, in conjunction with the transceiver 212, may receive the extracted crowd-sensed data from the data source server 106 over the communication network 112. Thereafter, the data extracting processor 204 may store the extracted crowd-sensed data in the storage device, such as, the memory 208 or the crowd-sensed database server 108A. The storage of the extracted crowd-sensed data has been explained in detail in conjunction with step 306.

At step 306, the extracted crowd-sensed data is stored in the crowd-sensed database server 108A. In an embodiment, the data extracting processor 204, in conjunction with the transceiver 212, may be configured to store the extracted crowd-sensed data in the crowd-sensed database server 108A. In an embodiment, data extracting processor 204, in conjunction with the transceiver 212, may store the extracted crowd-sensed data in the crowd-sensed database server 108A in the standardized format as defined by the service provider. The standardized format may be based on at least the location, the time, and the event category associated with each of the extracted crowd-sensed data.

Prior to the storage of the extracted crowd-sensed data in the crowd-sensed database server 108A, the processor 202 may be configured to determine the location, the time, and the event category associated with each of the extracted crowd-sensed data. In an embodiment, the processor 202 may determine the location associated with each of the crowd-sensed data based on at least the content in each of the extracted crowd-sensed data. Generally, the one or more individuals, who are discussing or reporting about the one or more events on the data source server 106, may include the location information associated with the one or more events in the discussed or reported data (i.e., the crowd-sensed data). Based on the location information, the processor 202 may determine the location of each of the extracted crowd-sensed data. In a scenario where the extracted crowd-sensed data is independent of the location information, the processor 202 may be configured to extract one or more noun phrases from the extracted crowd-sensed data. The processor 202 may utilize one or more standard tools known in the art, for example, Stanford-CoreNLP® toolkit, to extract the one or more noun phrases from the extracted crowd-sensed data. Thereafter, the processor 202 may determine a latitude and longitude information pertaining to each of the extracted crowd-sensed data based on at least the determined one or more noun phrases. For example, the processor 202 may transmit the determined one or more noun phrases to google API and parse the JavaScript Object Notation (JSON) response to get the latitude and longitude information pertaining to each of the extracted crowd-sensed data. Thereafter, the processor 202 may determine the location of each of the extracted crowd-sensed data based on at least the determined latitude and longitude information.

Further, in an embodiment, the processor 202 may be configured to determine the time (or the time duration) associated with each of the extracted crowd-sensed data. The time (or the time duration) may correspond to an instance (or a sequence of instances) at which (or during which) an event that corresponds to the one or more events may have occurred at the one or more locations of the geographical area. In an embodiment, the processor 202 may determine the time (or the time duration) associated with each of the extracted crowd-sensed data based on at least the time-stamp associated with each of the extracted crowd-sensed data. In another embodiment, the processor 202 may determine the time (or the time duration) associated with each of the extracted crowd-sensed data based on at least the content in each of the extracted crowd-sensed data. For example, the one or more individuals may include the time information while discussing or reporting about the event that corresponds to the one or more events in the discussed or reported data (i.e., the crowd-sensed data). Based on the time information in the extracted crowd-sensed, the processor 202 may determine the time (or the time duration) associated with each of the extracted crowd-sensed data.

Further, in an embodiment, the processor 202 may be configured to determine the event category of each of the extracted crowd-sensed data. In an embodiment, the processor 202 may determine the event category based on at least the content associated with each of the extracted crowd-sensed data. The processor 202 may be configured to extract one or more keywords and phrases from the content of each of the extracted crowd-sensed data. Thereafter, for each extracted crowd-sensed data, the processor 202 may determine an event category score pertaining to each of the one or more events based on at least a comparison of the extracted one or more keywords and phrases with a look-up dictionary. In an embodiment, the processor 202 may generate the look-up dictionary. The look-up dictionary may be generated based on historical crowd-sensed data. The processor 202 may extract one or more relevant keywords and phrases from the historical crowd-sensed data for each of one or more event categories. The one or more relevant keywords and phrases for each event category are identified from ground truth corpus of the historical crowd-sensed data using term frequency-inverse document frequency (TF-IDF) scores. The processor 202 may pre-process the historical crowd-sensed data prior to determination of the TF-IDF scores. The pre-processing of the historical crowd-sensed data includes steps of parts-of-speech tagging, removal of proper nouns, cleaning of content (e.g., text), spell correction, removal of stop words, stemming, and/or the like. Thereafter, the processor 202 may be configured to generate unigrams and n-grams from the pre-processed historical crowd-sensed data. Thereafter, the processor 202 may determine the one or more relevant keywords and phrases from the generated unigrams and n-grams using the corresponding TF-IDF scores. In another embodiment, the look-up dictionary may be provided by the service provider.

Thereafter, for each of the extracted crowd-sensed data, the processor 202 may be configured to determine one or more matching keywords and phrases based on at least the comparison of the extracted one or more keywords and phrases associated with each of the extracted crowd-sensed data with the generated look-up dictionary. Further, for each of the extracted crowd-sensed data, the processor 202 may determine the event category score for each of the one or more event categories based on at least the determined one or more matching keywords and phrases. Thereafter, for each of the extracted crowd-sensed data, the processor 202 may determine the event category from the one or more event categories that correspond to the one or more events based on the determined event category scores. For example, the event category from the one or more event categories, having the highest event category score, is determined as the event category of the extracted crowd-sensed data.

In an embodiment, the processor 202 may utilize one or more trained classifiers to determine the event category of each of the extracted crowd-sensed data. The one or more classifiers may be trained based on the historical crowd-sensed data. For example, the one or more classifiers may be trained upon the one or more known event categories and their corresponding one or more relevant keywords and phrases that are extracted from the historical crowd-sensed data. Thereafter, the processor 202 may feed or provide the extracted one or more keywords and phrases, for each extracted crowd-sensed data, as input to the trained one or more classifiers. The trained one or more classifiers may classify the each extracted crowd-sensed data into one of the one or more event categories.

After determining the location, the time, and the event category for each of the extracted crowd-sensed data, the processor 202, in conjunction with the data extracting processor 204 and the transceiver 212, may store the extracted crowd-sensed data in the storage device, such as, the memory 208 or the crowd-sensed database server 108A, in the standardized format. The standardized format is based on at least the determined location, the determined time, and the determined event category associated with each of the extracted crowd-sensed data.

At step 308, the stored crowd-sensed data is aggregated based on at least the determined location and the determined event category of each of the stored crowd-sensed data. In an embodiment, the data aggregating processor 206 may be configured to aggregate the stored crowd-sensed data based on at least the determined location and the determined event category of each of the stored crowd-sensed data. In an embodiment, the processor 202 may be configured to identify the one or more distinct event categories associated with the stored crowd-sensed data by aggregating the stored crowd-sensed data that corresponds to same event category. For example, if there are two reports pertaining to pothole at a location, say “location-A,” then based on the location and event category context, it may be inferred that there is a single event of road-condition (i.e., pothole) at the “location-A” and there are two instances of reporting the same event at the same location.

Prior to the aggregation of the stored crowd-sensed data, the processor 202 may be configured to validate each of the stored crowd-sensed data. The processor 202 may utilize an expectation maximization-based iterative algorithm to simultaneously estimate a reliability of each of the one or more data sources, a reputation score of each of the one or more data sources, and a likelihood of occurrence of the one or more events. Based on at least one or more of the reliability of each of the one or more data sources, the reputation score of each of the one or more data sources, and the likelihood of occurrence of the one or more events, the processor 202 may validate each of the stored crowd-sensed data.

Further, in an embodiment, the processor 202 may be configured to determine the association of each of the stored crowd-sensed data with a reference location that corresponds to the one or more reference locations of the geographical area. In an embodiment, the service provider (or the requestor) may provide the one or more reference locations of the geographical area. In an embodiment, the processor 202 may determine the association of each of the stored crowd-sensed data with the reference location based on at least the threshold distance associated with the reference location. In an embodiment, the processor 202 may perform a check to determine if the determined location of the stored crowd-sensed data is within the threshold distance of at least one of the one or more reference locations. In order to perform the check, the processor 202 may determine a distance (e.g., Euclidean distance) of the stored crowd-sensed data from the at least one of the one or more reference locations. In case the processor 202 determines that the determined distance of the stored crowd-sensed data is less than the threshold distance of the at least one of the one or more reference locations, then the processor 202 may associate the stored crowd-sensed data to the at least one of the one or more reference locations. In case of more than one association of the stored crowd-sensed data with the one or more reference locations, the processor 202 may associate the stored crowd-sensed data to the reference location that is nearest neighbor to the stored crowd-sensed data. In a scenario where the determined distance of the stored crowd-sensed data is not within the threshold distance of any of the one or more reference locations, then the processor 202 may not associate the stored crowd-sensed data to any of the one or more reference locations. In such scenario, the processor 202 may determine a new reference location for similar crowd-sensed data (with same event category that is not associated to any of the one or more reference locations). The processor 202 may determine the new reference location for the similar crowd-sensed data based on at least the latitude and longitude information associated with the similar crowd-sensed data. The latitude information of the new reference location may correspond to a mean value of the latitude information associated with the similar crowd-sensed data. Similarly, the longitude information of the new reference location may correspond to a mean value of the longitude information associated with the similar crowd-sensed data.

In an embodiment, after determining the association of each of the stored crowd-sensed data with the one or more reference locations (including the new reference location), the processor 202 may update the determined location of each of the stored crowd-sensed data with the determined one or more reference locations (including the new reference location). Thereafter, in an embodiment, the data aggregating processor 206 may aggregate the stored crowd-sensed data based on at least the updated determined location (i.e., the one or more reference locations) and the determined event category of each of the stored crowd-sensed data. Based on at least the aggregation, the processor 202 may generate the one or more sets of aggregated data. Each of the one or more sets of aggregated data may correspond to a distinct event category that further corresponds to the one or more event categories.

Further, in an embodiment, for one or more of the one or more event categories, the stored crowd-sensed data may be ephemeral in nature. For example, an event, such as, a traffic jam at a location, may occur during peak hours, however, the same event may not exist after a couple of hours. For such one or more of the one or more event categories, the data aggregating processor 206 may be configured to aggregate the stored crowd-sensed data based on the time factor associated with the stored crowd-sensed data. In an embodiment, to capture the ephemeral nature in the stored crowd-sensed data, the processor 202 may be configured to perform a division of time into the one or more time buckets. The granularity of the one or more time buckets and the total time to be divided may vary across the one or more event categories. In such a scenario, the data aggregating processor 206 may be configured to aggregate the stored crowd-sensed data of an event category, within a time bucket and within the threshold distance of a reference location, to generate a set of aggregated data. The set of aggregated data may correspond to the distinct event category and a count of data in the set of aggregated data may correspond to a number of instances of reporting the same distinct event category during the same time bucket at the same location.

In an exemplary scenario, the data aggregating processor 206 may utilize the following algorithm for aggregating the stored crowd-sensed data as discussed above in reference to step 308:

```
Context-based data aggregation:
Input: [symbol]  , I, [symbol]  , C, ρ.
Output: I'.
I′= I
for all r ϵ [symbol]   do
  if C(r) is ephemeral then
I″ = {i ϵ I′|(C(i) = C(r)) [symbol]   (LowTime(i) ≤ time(r) ≤ HighTime (i))}
{extract the existing events of the category C(r) and at the time bucket
pertaining to the report time}
  else
  I″ = (i ϵ I′|(C(i) = C(r))
  {extract the existing events of the category C(r)}
  end if
  if I″ ≠ ∅ then
  i = FindNearestEvents (r, I″)
  end if
if distance(i, r) ≤ ρ [symbol]   I″ ≠ ∅ then {add the crowd-sensed data to the
existing event} [symbol]
  (i) = [symbol]  (i) ∪ {r}
if [symbol]   ι ϵ [symbol]   such that location(i) = location(ι) then {update event location
to mean of all reports in case the event is not near a reference location}
  $location ( i ) \text{=} \text{<} \frac{{\sum }_{x ∈ ℛ i}^{ } lattitude of x}{\vert ℛ i \vert} , \frac{{\sum }_{x ∈ ℛ i}^{ } longitude of x}{\vert ℛ i \vert} >$
  end if
  else {create new event}
  create new event i of the category C(r)
  set time of the event i to that of the report r
  ι = FindNearestReferenceLocation(r, [symbol]   )
if distance(ι, r) ≤ p then {pivot the location of event to a reference
location}
  set location (i.e., <latitude, longitude>) of i to that of ι
else {otherwise event location is the same as the crowd-sensed data
location}
  set location (i.e., <latitude, longitude>) of i to that of r
  end if
  I′ = I′ ∪ {i}
  end if
end for
Return I′.
where, [symbol]
: corresponds to a set of extracted crowd-sensed data;
I: corresponds to a set of one or more existing events; [symbol]
: corresponds to a set of one or more reference locations,
C: corresponds to a set of one or more event categories,
ρ: corresponds to a threshold distance;
I′: corresponds to a set of one or more distinct events; and
r: corresponds to an extracted crowd-sensed data that corresponds to the set of extracted crowd-sensed data.
```

At step 310, the severity of each of the one or more events that corresponds to the one or more sets of aggregated data is determined. The severity of an event may be representative of a degree of attention that the event may require from one or more concerned authorities in terms of taking one or more actions to resolve problems associated with the event. In an embodiment, the processor 202 may be configured to determine the severity of the one or more events. The processor 202 may determine the severity of each of the one or more events based on at least two factors, for example, a volume and recency associated with each of the one or more events. The volume of the event may correspond to the count of extracted crowd-sensed data that is contributing to the event. The recency of the event may correspond to a timestamp of latest crowd-sensed data that is contributing to the event. In an embodiment, the two factors i.e., the volume and the recency, are intuitive in nature. For example, a high number of crowd-sensed data about a particular event may indicate a high degree of actions required for the particular event. Similarly, most recent crowd-sensed data about a particular event may indicate that the particular event is highly talked about among the one or more individuals and hence, the particular event may require a quicker resolution. Further, in an embodiment, the two factors i.e., the volume and the recency, may be influenced by the event category of crowd-sensed data. For example, a traffic event category may have a high volume of crowd-sensed data in comparison with a garbage event category. Therefore, the processor 202 may be configured to normalize each factor within each category. In an embodiment, for each event category “i,” the processor 202 may determine the volume of crowd-sensed data “v(i),” normalized by maximum volume with the same category, and the recency, normalized by most recent crowd-sensed data with the same category, by use of equation 1:

$$σ ( i ) = α \frac{v ( i )}{{max}_{j ∈ I} v ( j )} + ( 1 - α ) ( 1 - \frac{τ ( i )}{{max}_{j ∈ I} τ ( j )} ) \qquad ( 1 )$$

With reference to equation 1, if Σ(i) is the time elapsed after the last crowd-sensed data is extracted for the event category “i,” then

$$( 1 - \frac{τ ( i )}{{max}_{j ∈ I} τ ( j )} )$$

provides a measure of recency, which becomes higher when the time elapsed from the last extracted crowd-sensed data is lower. In an embodiment, the volume and the recency are further weighted by a pre-defined parameter “α,” such that 0≦α≦1. The pre-defined parameter “α” may capture the importance of the volume of crowd-sensed data in determining the severity.

At step 312, the one or more graphical distributions of the one or more events are generated. The one or more graphical distributions are representative of at least the spatial distribution, the temporal distribution, and the frequency distribution, or a combination thereof, of the one or more events in the geographical area. In an embodiment, the processor 202 may be configured to generate the one or more graphical distributions of the one or more events. In an embodiment, the processor 202 may generate the one or more graphical distributions of the one or more events based on at least the one or more sets of the aggregated data and the severity of each of the one or more events. In an embodiment, based on the request for one or more types of the one or more graphical distributions received from the service provider-computing device 102 or the requestor-computing device 104, the processor 202 may be configured to select one or more of the one or more sets of the aggregated data and the associated severity. Thereafter, based on the received request, the processor 202 may generate the one or more graphical distributions based on the selected one or more of the one or more sets of the aggregated data and the associated severity. After generating the one or more graphical distributions, the processor 202 may store the generated one or more graphical distributions into the storage device, such as, the memory 208 or the database server 108.

At step 314, the generated one or more graphical distributions of the one or more events are rendered on the GUI displayed on the display screen of the service provider-computing device 102 or the requestor-computing device 104. In an embodiment, the processor 202 may be configured to render the generated one or more graphical distributions of the one or more events on the GUI displayed on the display screen of the service provider-computing device 102 or the requestor-computing device 104. Further, the requestor may utilize the rendered one or more graphical distributions, displaying at least the one or more events of the geographical area, a status associated with the one or more events, and the one or more actionable insights corresponding to the one or more events, to provide the resolution to each of the one or more events in the geographical area. The control passes to the end step 316.

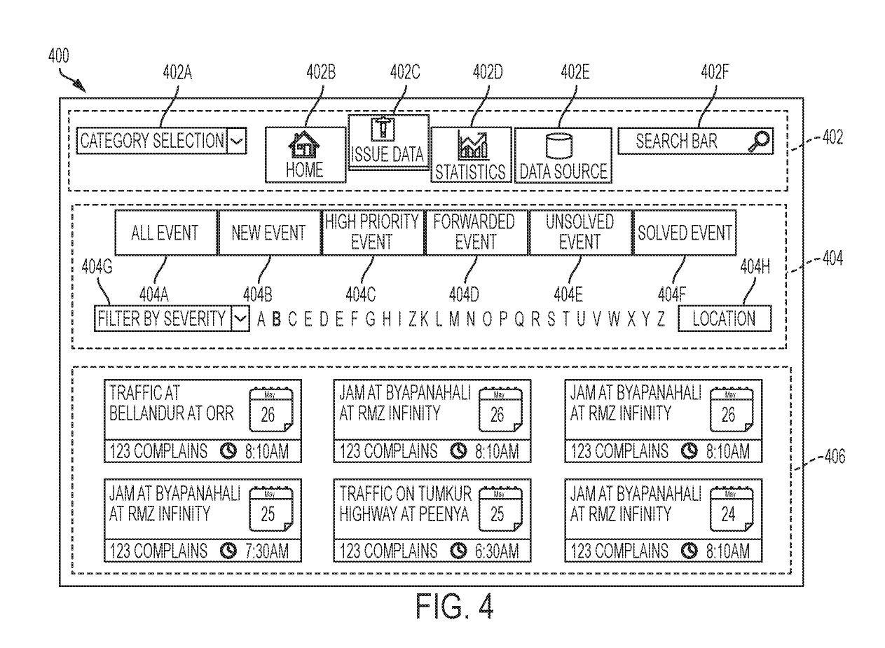

FIG. 4 is a block diagram that illustrates a visualization dashboard displaying the one or more actionable insights corresponding to the one or more events in the geographical area, in accordance with an embodiment. With reference to FIG. 4, there is shown a visualization dashboard, such as, a GUI 400, that is described in conjunction with elements from FIGS. 1-3. The GUI 400 comprises a menu-based structure based on two hierarchies of information, i.e., real-time crowd-sensed data and stored crowd-sensed data. The GUI 400 may comprise at least three types of visualizations, for example, a tile view, a graph view, and a list view. Each of the at least three types of visualizations may enable the requestor to smoothly operate the system and features with minimal navigation.

With reference to FIG. 4, the GUI 400 is divided into row layout. The GUI 400 includes a navigation section 402, a filter section 404, and a visualization section 406. The navigation section 402 is configured to provide navigational facilities to different functionalities and features with the visualization dashboard. The filter section 404 is configured to provide filtration facilities to the requestor. The visualization section 406 is configured to display the one or more sets of aggregated data and the corresponding volume and recency.

The navigation section 402 may comprise one or more tabs, such as, a category selection tab 402A, a home tab 402B, an issue data tab 402C, a statistics tab 402D, a data source tab 402E, and a search bar tab 402F. In an embodiment, the requestor may click on a tab, such as, the category selection tab 402A, to select at least one event category that corresponds to the one or more event categories. In an embodiment, the requestor may click on a tab, such as, the home tab 402B, to return back to the home page of the visualization dashboard. In an embodiment, the requestor may further click on a tab, such as, the issue data tab 402C, to view the real-time crowd-sensed data and the stored crowd-sensed data with the real-time crowd-sensed data in priority. In an embodiment, the requestor may further click on a tab, such as, the statistics tab 402D, to view and analyze the statistical data (e.g., the generated one or more graphical distributions) in comparison to varied time frames. In an embodiment, the requestor may further click on a tab, such as, the data source tab 402E, to view the one or more data sources from which the stored crowd-sensed data may have been extracted. In an embodiment, the requestor may further click on a tab, such as, the search bar tab 402F, to input one or more keywords associated with the one or more events. In response to the inputted one or more keywords, the processor 202 may update the visualization section 406 on the GUI 400.

The filter section 404 may comprise one or more tabs, such as, all event tab 404A, a new event tab 404B, a high priority event tab 404C, a forwarded event tab 404D, an unsolved event tab 404E, a solved event tab 404F, a severity filtering tab 404G, and a location tab 404H. In an embodiment, the requestor may click on a tab, such as, the all event tab 404A, to view a list of all of the one or more events that are being discussed or reported by the one or more individuals over the data source server 106. In an embodiment, the requestor may further click on a tab, such as, the new event tab 404B, to view a list of the one or more events that may be new to the requestor i.e., the requestor may not have accounted such events in the past. In an embodiment, the requestor may further click on a tab, such as, the high priority event tab 404C, to view a list of the one or more events that may be highly prioritized based on the at least the volume and recency associated with the one or more events. In an embodiment, the requestor may further click on a tab, such as, the forwarded event tab 404D, to view a list of the one or more events that may have been forwarded by other individuals, such as, the service provider or other requestor. In an embodiment, the requestor may further click on a tab, such as, the unsolved event tab 404E, to view a list of the one or more events that have not solved yet. In an embodiment, the requestor may further click on a tab, such as, the solved event tab 404F, to view a list of the one or more events that have resolved. In an embodiment, the requestor may further click on a tab, such as, the severity filtering tab 404G, to select a severity value so as to view a list of the one or more events that may require attention based on the selected severity value. In an embodiment, the requestor may further click on a tab, such as, the location tab 404H, to select a location from the one or more locations in the geographical area so as to view a list of the one or more events that are associated with the selected location.

The visualization section 406 may display the various views of the one or more sets of aggregated data, such as, text data, visualized data, and graphed data. The visualization section 406 may further display the volume and the recency associated with each of the one or more event categories identified from the real-time crowd-sensed data and the stored crowd-sensed data. Such information visualization may enable the individual, such as, the service provider or the requestor, to easily monitor a summary of all incoming data (i.e., the real-time crowd-sensed data and the stored crowd-sensed data), in parallel with an action of monitoring the incoming data with the one or more graphical distributions.

The disclosed embodiments encompass numerous advantages. The disclosure provides a method and a system for processing the crowd-sensed data. The crowd-sensed data may comprise the real-time crowd-sensed data and the stored crowd-sensed data. Irrespective of the data sources, the crowd-sensed data is stored in the standardized format based on the time, location, and the event category. Further, the standardized crowd-sensed data is aggregated to identify distinct events (i.e., issues) in an online manner, such that each of the distinct events is pivoted to a landmark location of the geographical area. Such aggregated information may be further utilized to extract the various meaningful insights of the events in the geographical area. Further, the disclosed method models the severity of the various events based on the crowd-sensed data, coming from the different data sources, based on the volume, density, and recency of the crowd-sensed data pertaining to the various events. Further, the disclosed system may facilitate the visualization dashboard that may be configured to visualize or render the spatial and temporal distributions of the various distinct events, hence, providing at-a-glance insights to the individual, such as, a city administrator, in identifying the most problematic events in the one or more locations of the geographical area, and subsequently, prioritize their operations accordingly.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive, such as, a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or other similar devices that enable the computer system to connect to databases and networks, such as, LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or only hardware, or using a varying combination of the two techniques. The disclosure is independent of the programming language and the operating system used in the computers. The instructions for the disclosure can be written in all programming languages, including, but not limited to, ‘C’, ‘C++’, ‘Visual C++’ and ‘Visual Basic’. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, ‘Unix’, DOS′, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for processing crowd-sensed data to generate actionable insights of geographical areas. However, it should be apparent to those skilled in the art that modifications in addition to those described are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or used, or combined with other elements, components, or steps that are not expressly referenced.

A person having ordinary skill in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for processing crowd-sensed data to generate actionable insights of geographical areas, the method comprising:
extracting, by one or more data extracting processors at a computing server, the crowd-sensed data, corresponding to one or more events in a geographical area, from one or more data sources over a communication network, wherein the extracted crowd-sensed data is stored in a storage device based on at least a time, a location, and an event category associated with the extracted crowd-sensed data;
aggregating, by the one or more data aggregating processors at the computing server, the stored crowd-sensed data based on at least the location and the event category to generate one or more sets of aggregated data, wherein each of the one or more sets of aggregated data is associated with an event of the one or more events in the geographical area; and
rendering, by one or more processors at the computing server, one or more graphical distributions of the one or more events in the geographical area, based on at least the generated one or more sets of aggregated data, on a user interface displayed on a display screen of a computing device, wherein the one or more graphical distributions of the one or more events are representative of one or more actionable insights of the geographical area.

2. The method of claim 1, wherein the one or more data sources correspond to one or more of: one or more social media sources, one or more open online forums, one or more mobile applications, and one or more online web sources.

3. The method of claim 1, wherein the time associated with the extracted crowd-sensed data is determined, by the one or more processors, based on a timestamp associated with the extracted crowd-sensed data.

4. The method of claim 1, wherein the event category and the location associated with the extracted crowd-sensed data are determined, by the one or more processors, based on at least content in the extracted crowd-sensed data, wherein the content is indicative of at least an occurrence of the one or more events at one or more locations.

5. The method of claim 4 further comprising determining, by the one or more processors, one or more noun phrases from the content in the extracted crowd-sensed data, when the content in the extracted crowd-sensed data is independent of location information.

6. The method of claim 5 further comprising determining, by the one or more processors, a latitude and longitude information pertaining to the extracted crowd-sensed data based on at least the one or more noun phrases.

7. The method of claim 6, wherein the location of the extracted crowd-sensed data is determined, by the one or more processors, based on the determined latitude and longitude information.

8. The method of claim 7 further comprising updating, by the one or more processors, the determined location based on a mean of the latitude information and the longitude information pertaining to the extracted crowd-sensed data, when the determined location is beyond a threshold distance of each of one or more reference locations.

9. The method of claim 1, wherein the aggregation of the stored crowd-sensed data is further determined, by the one or more data aggregating processors, based on an association of the one or more events with one or more reference locations.

10. The method of claim 9, wherein the association of the one or more events with the one or more reference locations is determined, by the one or more data aggregating processors, based on a comparison of the location with the one or more reference locations by use of at least a threshold distance associated with each of the one or more reference locations.

11. A system for processing crowd-sensed data to generate actionable insights of geographical areas, the system comprising:
one or more data extracting processors configured to:
extract the crowd-sensed data, corresponding to one or more events in a geographical area, from one or more data sources over a communication network, wherein the extracted crowd-sensed data is stored in a storage device based on at least a time, a location, and an event category associated with the extracted crowd-sensed data;
one or more data aggregating processors configured to:
aggregate the stored crowd-sensed data based on at least the location and the event category to generate one or more sets of aggregated data, wherein each of the one or more sets of aggregated data is associated with an event of the one or more events in the geographical area; and
one or more processors configured to:
render one or more graphical distributions of the one or more events in the geographical area, based on at least the generated one or more sets of aggregated data, on a user interface displayed on a display screen of a computing device, wherein the one or more graphical distributions of the one or more events are representative of one or more actionable insights of the geographical area.

12. The system of claim 11, wherein the one or more processors are further configured to determine the time associated with the extracted crowd-sensed data based on a timestamp associated with the extracted crowd-sensed data.

13. The system of claim 11, wherein the one or more processors are further configured to determine the event category and the location associated with the extracted crowd-sensed data based on at least content in the extracted crowd-sensed data, wherein the content is indicative of at least an occurrence of the one or more events at one or more locations.

14. The system of claim 13, wherein the one or more processors are further configured to determine one or more noun phrases from the content in the extracted crowd-sensed data, when the content in the extracted crowd-sensed data is independent of location information.

15. The system of claim 14, wherein the one or more processors are further configured to determine a latitude and longitude information pertaining to the extracted crowd-sensed data based on at least the one or more noun phrases.

16. The system of claim 15, wherein the one or more processors are further configured to determine the location of the extracted crowd-sensed data based on the latitude and longitude information.

17. The system of claim 16, wherein the one or more processors are further configured to update the determined location based on a mean of the latitude information and the longitude information pertaining to the extracted crowd-sensed data, when the determined location is beyond a threshold distance of each of one or more reference locations.

18. The system of claim 11, wherein the one or more processors are further configured to determine the aggregation of the stored crowd-sensed data based on an association of the one or more events with one or more reference locations.

19. The system of claim 18, wherein the one or more processors are further configured to determine the association of the one or more events with the one or more reference locations based on a comparison of the location with the one or more reference locations by use of at least a threshold distance associated with each of the one or more reference locations.

20. program product for use with a computer, the computer program product comprising a non-transitory computer readable medium, wherein the non-transitory computer readable medium stores a computer program code for processing crowd-sensed data to generate actionable insights of geographical areas, wherein the computer program code is executable by one or more processors to:
extract the crowd-sensed data, corresponding to one or more events in a geographical area, from one or more data sources over a communication network, wherein the extracted crowd-sensed data is stored in a storage device based on at least a time, a location, and an event category associated with the extracted crowd-sensed data;
aggregate the stored crowd-sensed data based on at least the location and the event category to generate one or more sets of aggregated data, wherein each of the one or more sets of aggregated data is associated with an event of one or more events in the geographical area; and
render one or more graphical distributions of the one or more events, based on the generated one or more sets of aggregated data, on a user interface displayed on a display screen of a computing device, wherein the one or more graphical distributions of the one or more events are representative of one or more actionable insights of the geographical area.
